(19) United States
(12) Patent Application Publication
(10) Pub. No.: US 2025/0346404 A1
(43) Pub. Date: Nov. 13, 2025

(54) BAG ASSEMBLY HAVING A FRONT PANEL ZIPPER ASSEMBLY AND TEAR STRIP

(71) Applicant: Illinois Tool Works Inc., Glenview, IL (US)

(72) Inventors: Eric P. Plourde, Frankfort, IL (US); Jose Manuel Septien Rojas, Naperville, IL (US)

(73) Assignee: Illinois Tool Works Inc., Glenview, IL (US)

(21) Appl. No.: 19/098,674

(22) Filed: Apr. 2, 2025

Related U.S. Application Data
(60) Provisional application No. 63/646,419, filed on May 13, 2024.

(51) Int. Cl. B65D 33/25; B65D 75/58

(52) U.S. Cl. CPC B65D 33/2533; B65D 75/5805

(57) ABSTRACT

A resealable bag assembly can include an open-ended bag and a zipper assembly having a tear strip. Interlocking profile bodies of the zipper assembly can repeatedly mate with each other to seal the bag closed and separate from each other to open the bag. The tear strip can be pulled to tear an opening through the zipper assembly. In contrast to some known bag assemblies having tear strips along top edges, top bends, or top folds in the bag assemblies, one or more examples of the zipper assemblies described herein may position the tear strip along a front side or surface of the bag assembly, which also can be the surface of the bag assembly that is presented to a consumer and may include indicia identifying the product inside the bag assembly and/or the entity manufacturing or selling the product.

### CROSS-REFERENCE TO RELATED APPLICATIONS

This application claims priority to U.S. Provisional Application No. 63/646,419 (filed 13 May 2024), the entire disclosure of which is incorporated herein by reference.

### BACKGROUND

### Technical Field

The subject matter described herein relates to bag assemblies having zippers inside the bag assemblies along the front panels of the bag assemblies, and tear strips used to tear openings into the bag assemblies for accessing the zipper assemblies.

### Discussion of Art

Some known bag assemblies or pouches can have front-panel openings with press-to-close reclosable zippers. These bag assemblies can have the zippers coupled to inside surfaces of panels of the bag assemblies. The panels of the bag assemblies may be sealed together above the zipper assemblies so that consumers or users cannot access the zippers inside the bag assemblies. Tear strips may be disposed inside the bag assemblies above the zipper assemblies. The tear strips can be adhered to the zipper assemblies. The tear strips are grasped and pulled to tear openings into the bag assemblies. Users or consumers can reach into the bag assemblies through these tear strip openings to reach the zipper assemblies. The users or consumers can then pull apart the zipper assemblies to access the contents in interior volumes of the bag assemblies (e.g., below the zipper assemblies).

After tearing a hole in the front panel and opening the zipper assembly, the zipper assembly can be pressed to close off the interior volume of the bag assembly and protect or maintain the quality of the product inside the bag assembly. If the tear strip ends up tearing the front panel at an angle that extends below the zipper assembly, however, then the bag assembly cannot be resealed to protect or maintain the quality of the product inside the bag assembly. This errant tearing of the front panel effectively opens the interior volume of the bag assembly to the ambient environment without being able to re-seal this volume from the ambient environment.

Additionally, holes or openings may need to be cut through the front walls or panels of the bags to provide consumers with access to the tear strip. For example, a hole may be punched through the front wall or panel of a bag so that a consumer can grasp the tear strip, or a tab connected with the tear strip. The consumer can then pull the tear strip to tear through the front wall or panel, thereby giving the consumer access to the zipper assembly. But cutting or punching this opening to access the tear strip can be difficult. For example, the panels or walls of a bag may be formed from thinner and/or weaker material than the zipper assembly. Care must be taken to cut through front panel, but not the zipper assembly or the back panel, to provide this opening. This can increase the cost and/or complexity of manufacturing the bag assemblies.

### BRIEF DESCRIPTION

A resealable bag assembly can include one or more webs of material that define (e.g., form) an open-ended bag. This bag may partially enclose an interior volume. For example, the bag may enclose the interior volume but for an open end of the bag. The bag can have one or more bag edges extending around and defining a mouth opening of the bag through which the interior volume is accessible. This mouth opening may be at or may define the open end of the bag. A zipper assembly includes a tear strip, one or more flanges, and interlocking profile bodies protruding from the one or more flanges. The interlocking profile bodies can repeatedly mate with each other to seal the mouth opening closed and separate from each other to open the mouth opening. The zipper assembly can extend from a closed end to an opposite open end with the one or more flanges extending from the closed end to opposing flange edges located at the open end of the zipper assembly. The tear strip can be located between the closed end and the open end of the zipper assembly. The tear strip may be part of the flange(s), may be embedded within the thickness of the flange(s), may be behind the flange(s), or the like. The tear strip can be pulled to tear a flange opening through the one or more flanges to provide access to the interlocking profile bodies. The flange edges of the zipper assembly can be coupled with the bag edges so that the closed end of the zipper assembly and the tear strip are disposed outside of the interior volume and outside of the mouth opening of the bag. In contrast to some known bag assemblies having tear strips along top edges, top bends, or top folds in the bag assemblies, one or more examples of the zipper assemblies described herein may position the tear strip along a front side or surface of the bag assembly, which also can be the surface of the bag assembly that is presented to a consumer and may include indicia identifying the product inside the bag assembly and/or the entity manufacturing or selling the product.

A method can include obtaining an open-ended bag formed from one or more webs of material that partially enclose an interior volume. The bag can have one or more bag edges extending around and defining a mouth opening of the bag through which the interior volume is accessible. The method can include obtaining a zipper assembly comprising a tear strip, one or more flanges, and interlocking profile bodies protruding from the one or more flanges. The interlocking profile bodies can repeatedly mate with each other to seal the mouth opening closed and separate from each other to open the mouth opening. The zipper assembly can extend from a closed end to an opposite open end with the one or more flanges extending from the closed end to opposing flange edges located at the open end of the zipper assembly. The tear strip can be pulled to tear a flange opening through the one or more flanges to provide access to the interlocking profile bodies. The method also can include sealing the flange edges of the zipper assembly with the bag closer to the bag edges than the interior volume so that the closed end of the zipper assembly and the tear strip are disposed outside of the interior volume and outside of the mouth opening of the bag.

Another bag assembly can include an open-mouthed bag partially extending around an interior volume and an open-mouthed zipper assembly having interlocking bodies protruding from one or more flanges and shaped to repeatedly mate with each other and separate from each other. The zipper assembly can include a tear strip that can be pulled to form a first opening through the zipper assembly. The zipper assembly and the open-mouthed bag can be sealed to each other to surround and enclose the interior volume of the bag with the tear strip and the interlocking bodies located outside of the open-mouthed bag.

### BRIEF DESCRIPTION OF THE DRAWINGS

The inventive subject matter may be understood from reading the following description of non-limiting embodiments, with reference to the attached drawings, wherein below:

FIG. 1 illustrates one example of a bag assembly;

FIG. 2 illustrates a cross-sectional view of the bag assembly along line A-A in FIG. 1;

FIG. 3 illustrates a cross-sectional view of another example of a bag assembly along line A-A shown in FIG. 1;

FIG. 4 illustrates a flowchart of one example of a method for providing a bag assembly; and

FIG. 5 illustrates another example of a bag assembly.

### DETAILED DESCRIPTION

One or more examples of the inventive subject matter described herein include bag assemblies having zipper assemblies attached to mouths of the bag assemblies so that the front-panel openings into the bag assemblies are through the side of the zipper assemblies, and not through the front panels of the bag assemblies. The zipper assemblies can extend above the face of the front panel or front bag wall. In this way, any punching or cutting to form an opening to access the tear strip (or tab of the tear strip), as well as sealing related to the tear tab, is done solely to the zipper assembly and not to the film forming the panels or walls of the bag assembly. Also, pulling the tear strip does not tear through the bag wall when the tear strip is pulled to open the bag assembly, but instead tears through the zipper assembly.

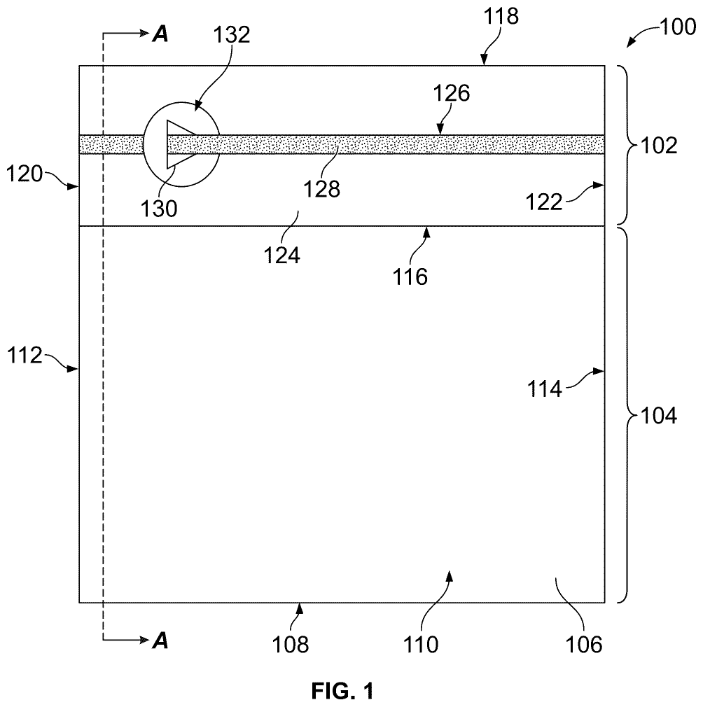

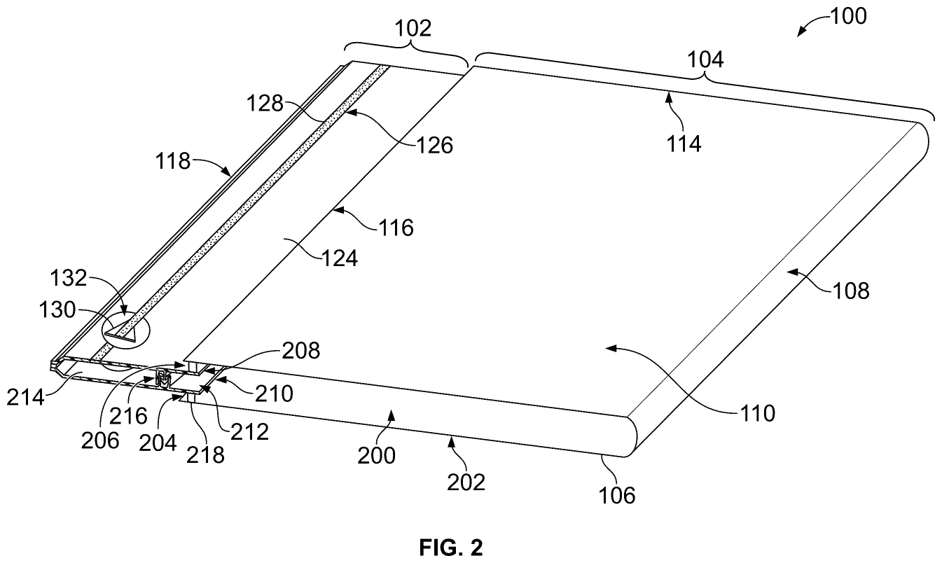

FIG. 1 illustrates one example of a bag assembly 100. FIG. 2 illustrates a cross-sectional view of the bag assembly 100 along line A-A in FIG. 1. The bag assembly 100 may be a resealable bag assembly in that the bag assembly 100 can be repeatedly unsealed and opened through a zipper assembly 102 and sealed and closed using the zipper assembly 102. The bag assembly 100 may include an open-ended bag 104 that partially encloses an interior volume 200 (shown in FIG. 2). Product may be held in this interior volume 200.

The bag 104 may be formed from one or more webs or films 106 of material. In the illustrated example, the bag 104 is formed from a single web or film 106 of material that is folded or bent along a bottom edge 108 of the bag 104. This fold or bend along the bottom edge 108 may form a front panel or wall 110 of the bag 104 and an opposing back panel or wall 202 (shown in FIG. 2) of the bag 104.

Opposite side edges of the front and back panels or walls 110, 202 may be sealed together (e.g., via a heat seal) to form opposite side edges 112, 114 of the bag 104. The side edges 112, 114, the bottom edge 108, and the front and rear panels or walls 110, 202 form the bag 104 that is open along the top of the panels 110, 202. The front and rear panels or walls 110, 202 have top edges 116, 204 (shown in FIG. 2) that are not joined with each other. This can leave an opening at the top of the panels 110, 202. This opening can be referred to as a mouth 206 (shown in FIG. 2) of the bag 104. The mouth 206 may be between and bounded by the top edges 116, 204 of the panels 110, 202 (and the sealing of the panels 110, 202 to each other at the side edges 112, 114).

The zipper assembly 102 may extend from a top edge 118 to opposite bottom edges 208, 210 (shown in FIG. 2), and from one side edge 120 to an opposite side edge 122. The zipper assembly 102 may be closed along the top edge 118 and the side edges 120, 122, but open along the bottom edges 208, 210. For example, the zipper assembly 102 may have a mouth 212 (shown in FIG. 2) along or between the bottom edges 208, 210. This mouth 212 may be bounded by the bottom edges 208, 210 of the zipper assembly 102 (and the bottom edges 208, 210 that are sealed together at the side edges 120, 122).

The zipper assembly 102 can be formed from two or more flanges 124, 214 (shown in FIG. 2). These flanges 124, 214 can be thicker or more durable than the panels 110, 202 of the bag 104. The flanges 124, 214 include interlocking bodies 216 that protrude from each of the flanges 124, 214 toward the other of the flanges 214, 124. These interlocking bodies 216 are shaped to repeatedly mate and separate from each other to repeatedly seal and unseal the interior volume 200 of the bag 104. For example, the interlocking body or bodies 216 protruding from one flange 124 or 214 may have a ridge shape (e.g., with or without a bulbous head) while the interlocking body or bodies 216 protruding from the other flange 214 or 124 may have a groove shape (e.g., a U-shaped or C-shaped receptacle) for receiving the head of the other interlocking body or bodies 216. Alternatively, the interlocking bodies 216 may have another shape.

In the illustrated example, the flanges 124, 214 are separate bodies that are sealed with each other. Each flange 124, 214 can have a top edge that is at the top edge 118 of the zipper assembly 102. Stated differently, the top edge 118 of the zipper assembly 102 is the top edges of the flanges 124, 214 in the illustrated example. The top edges 118 of the flanges 124, 214 may be sealed with each other using an adhesive, heat, and/or pressure. The flange 124 can extend from the top edge 118 to the bottom edge 208 and the flange 214 can extend from the top edge 118 to the bottom edge 210. The flanges 124, 214 can be sealed with each other along three edges 118, 120, 122 to form an open-mouthed header or open-mouthed zipper assembly of a bag, similar to the bag 104.

The zipper assembly 102 includes a tear strip 126 in the front flange 124. The tear strip 126 can be formed from a material that is more rigid or stronger than the material(s) from which the panels 110, 202 and/or the flanges 124, 214 are formed. For example, the flanges 124, 214 and/or panels 110, 202 may be formed from low density polyethylene (LDPE), while the tear strip 126 is formed from high density polyethylene (HDPE), polypropylene (PP), or a cyclic olefin copolymer (COC). The tear strip 126 optionally can be referred to as a tear cord.

The tear strip 126 includes an elongated body 128 coupled with a tab or head 130. The tab or head 130 may be part of the front flange 124 that remains from cutting an access opening 132 through the front flange 124 and optionally part of the back flange 214. The elongated body 128 may be partially or fully embedded in the front flange 124. For example, the tear strip 126 can be co-extruded with the front flange 124 such that the tear strip 126 is visible on the outside of the front flange 124 and zipper assembly 102, and such that the tear strip 126 divides the front flange 124 into two separate panels or webs of material. Optionally, the tear strip 126 may be fully embedded within the front flange 124. As another example, the tear strip 126 may be attached to an inside surface of the front flange 124, such as the surface of the front flange 124 that faces the back flange 214.

The zipper assembly 102 can be coupled with the bag 104 at or near the top edges 116, 204 of the panels 110, 202. For example, the mouth 212 of the zipper assembly 102 may face the mouth 206 of the bag 104. In the illustrated example, the zipper assembly 102 extends into the mouth 206 of the bag 104 with the mouth 212 of the zipper assembly 102 disposed inside of and opening into the mouth 206 of the bag 104. Optionally, the bag 104 may extend into the mouth 212 of the zipper assembly 102 with the mouth 206 of the bag 104 disposed inside of and opening into the mouth 212 of the zipper assembly 102.

The zipper assembly 102 can be joined to the bag 104 to close off the mouths 206, 212 of the bag 104 and the zipper assembly 102. For example, the zipper assembly 102 can be coupled with the bag 104 using seals 218 between the front panel 110 and the front flange 124 and between the rear panel 202 and the rear flange 214. These seals 218 can be heat seals between the zipper assembly 102 and the bag 104. In the illustrated example, the seals 218 join exterior surfaces of the flanges 124, 214 of the zipper assembly 102 with interior surfaces of the panels 110, 202 of the bag 104. In another example, the seals 218 can join interior surfaces of the flanges 124, 214 of the zipper assembly 102 with exterior surfaces of the panels 110, 202 of the bag 104.

The consumer can grasp the tab or head 130 and pull the tab or head 130 to separate the tear strip 126 from the front flange 124. This can tear a hole through the front flange 124 so that the consumer can reach inside the zipper assembly 102. The consumer can then pull the lower part of the front flange 124 away from the rear flange 214 to separate the interlocking bodies 216 from each other. The consumer can then access the interior volume 200 of the bag 104. The consumer can then press the interlocking bodies 216 together to seal the interior volume 200 closed again.

The tear strip 126 is positioned outside of the bag 104 with the tear strip 126 located between the top edge 118 (where the flanges 124, 214 are sealed together) and the interlocking bodies 216 and the panels 110, 202 of the bag 104. By placing the tear strip 126 outside of the panels 110, 202 of the bag 104, the pulling of the tear strip 126 cannot tear the panels 110, 202 and destroy the integrity of the seal provided by the interlocking bodies 216. For example, even if the tear strip 126 is pulled in such a way to tear through the front flange 124 at a downward angle toward the bag 104, the interlocking bodies 216 can stop this angled tear from reaching the panel 110. Additionally, punching the hole through the flange(s) 124, 214 to create the opening 132 for accessing the tear strip 126 does not risk punching or cutting any holes or openings through the panels 110, 202. This can eliminate a need for additional seals to maintain the integrity of the sealed interior volume 200 of the bag 104.

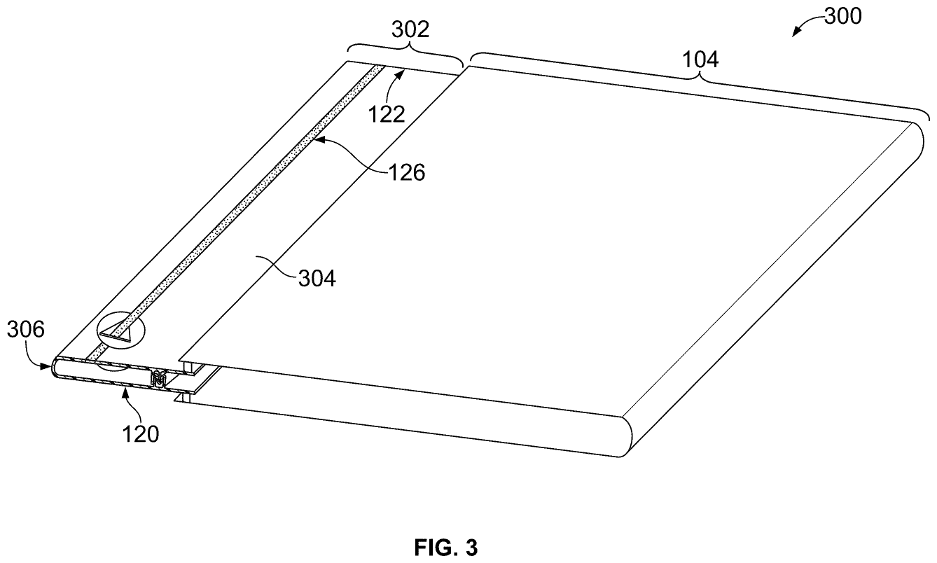

FIG. 3 illustrates a cross-sectional view of another example of a bag assembly 300 along line A-A shown in FIG. 1. The bag assembly 300 may represent the bag assembly 100 shown in FIG. 1 with a different zipper assembly 302. The bag assembly 300 may include the bag 104. The zipper assembly 302 may include the tear strip 126 and be similar to the zipper assembly 102, except that the zipper assembly 302 may include a single, continuous flange 304 that is folded over to have a bend 306 instead of having two flanges 124, 214 (shown in FIGS. 1 and 2) that are sealed together along the top edge 118 (shown in FIG. 1). The flange 304 may then be sealed to itself along the side edges 120, 122.

This allows for the zipper assembly 302 to be made from a single extrusion that is not slit or cut into separate flanges 124, 214. For example, the tear strip 126 and the single flange 304 can be co-extruded together, thereby reducing the cost and complexity of manufacturing the zipper assembly 302.

The bag assemblies 100, 300 shown in FIGS. 1 and 3 have the tear strips 126 positioned on, in, or behind the front flange 124, 304. This contrasts with some known zipper tape packages, which can include lines of weakness and/or a tear strip along the top edge or the bend at the top of the zipper assembly of the bag or package. Some bag assemblies 100, 300 may be designed to have the tear strip 126 along the front of the bag assembly 100, 300 between the top edge 118 or bend 306 and the bag 104 for aesthetic purposes.

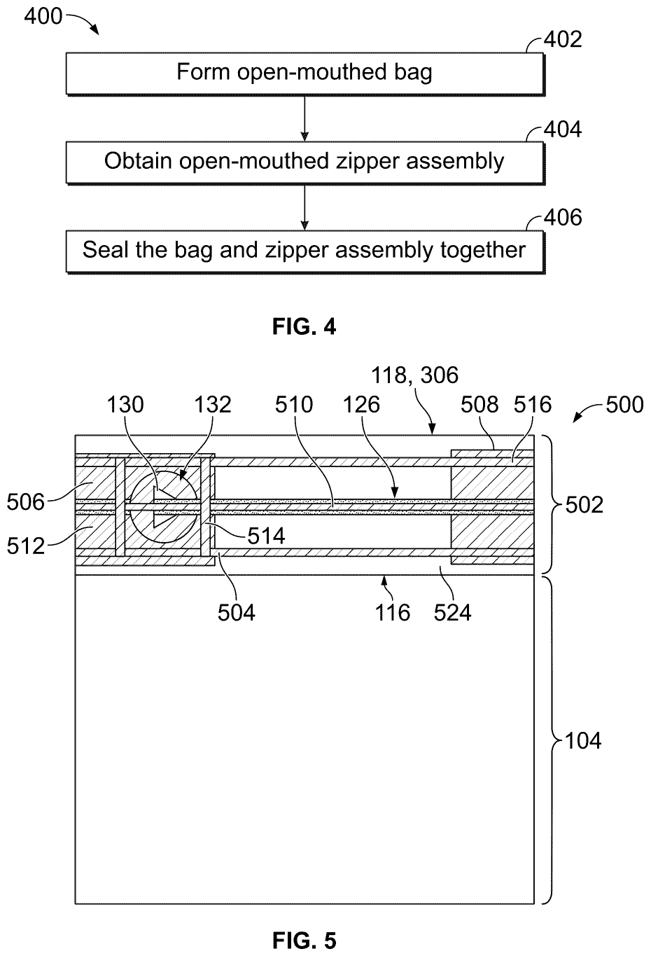

FIG. 4 illustrates a flowchart of one example of a method 400 for providing a bag assembly. The method 400 can represent operations that are performed to manufacture one or more of the bag assemblies described herein. At 402, an open-mouthed bag is formed. For example, a web of material is folded over to form opposing front and rear panels of a bag. Side edges of this folded web of material can be sealed to each other to create an open-mouthed bag, similar to the bag 104. Optionally, two separate panels may be cut from the web of material and sealed together along three edges to form an open-mouthed bag. At 404, a zipper assembly is obtained. The zipper assembly can be extruded as a single, planar body having the interlocking bodies protruding from different locations on the planar body. The planar body may then be cut into two flanges with each flange having at least one interlocking body that can mate with at least one of the interlocking bodies of the other flange, and at least one of the flanges including a tear strip. The flanges may then be sealed with each other along three edges to form the zipper assembly 102 as an open-mouthed bag similar to the bag 104.

Optionally, the zipper assembly can be extruded as a single, planar body having the interlocking bodies protruding from different locations on the planar body and the tear strip in a location between the interlocking bodies. The planar body may then be bent or folded so that the interlocking bodies are positioned to mate with each other, and the tear strip is positioned between the bend in the zipper assembly and at least one of the interlocking bodies.

At 406, the zipper assembly and the bag may be sealed to each other. The open mouth of the zipper assembly may be partially inserted into the open mouth of the bag, or the open mouth of the bag may be inserted into the open mouth of the zipper assembly. The panels of the bag and the flange(s) of the zipper assembly may then be sealed to each other to form the bag assembly.

FIG. 5 illustrates another example of a bag assembly 500. The bag assembly 500 can include a zipper assembly 502 that is similar or identical to the zipper assembly 102 and/or 302 except as stated below. The zipper assembly 502 includes a front flange 524 and an opposite rear flange that is behind the front flange 524 in FIG. 5. The front and rear flanges may be separate and joined by a seal at the top edge 118 or may be a single flange having the bend or fold 306. The zipper assembly 502 can be coupled with the bag 104 similar to the zipper assembly 102 and/or 302.

The zipper assembly 502 may include an inboard seal 504. This inboard seal 504 may be a peel seal between the front and rear flanges or between the portions of the flange that are on opposite sides of the bend 306. The inboard seal 504 can couple the front and rear flanges (or the flange portions) together in a location between (a) the tab 130 and/or opening 132 and (b) the bottom edges 208, 210 of the front and rear flanges (or flange portions), the interlocking bodies 216, and/or the top edges 116, 204 of the bag 104.

The zipper assembly 502 can include one or more side seals 506, 508 between the interior surfaces of the front and rear flanges that face each other (or between the interior surface of the different portions of the flange 304 on either side of the bend 306). At least one of these side seals 506 can be positioned to encapsulate the tab 130 and/or opening 132.

A peel seal 510 between the tear strip 126 and the rear flange (or the back portion of the flange 304 that is between the bend 306 and the rear panel or wall of the bag 104) also can be provided. Optionally, vertical seals 512, 514 that extend vertically (e.g., transverse to the tear strip 126) on either side of the tab 130 and/or opening 132 and/or horizontal seals 516, 504 that extend horizontally (e.g., parallel to the tear strip 126) on either side of the tab 130 and/or opening 132 can be provided to surround the tab 130 and/or opening 132. One or more of these additional seals can help seal the interior of the bag assembly 100, 300 from the opening 132 and prevent air, moisture, contaminants, etc. from passing through the opening 132 and reaching the interior of the bag assembly 100, 300.

A resealable bag assembly can include one or more webs of material that define (e.g., form) an open-ended bag. This bag may partially enclose an interior volume. For example, the bag may enclose the interior volume but for an open end of the bag. The bag can have one or more bag edges extending around and defining a mouth opening of the bag through which the interior volume is accessible. This mouth opening may be at or may define the open end of the bag. A zipper assembly includes a tear strip, one or more flanges, and interlocking profile bodies protruding from the one or more flanges. The interlocking profile bodies can repeatedly mate with each other to seal the mouth opening closed and separate from each other to open the mouth opening. The zipper assembly can extend from a closed end to an opposite open end with the one or more flanges extending from the closed end to opposing flange edges located at the open end of the zipper assembly. The tear strip can be located between the closed end and the open end of the zipper assembly. The tear strip may be part of the flange(s), may be embedded within the thickness of the flange(s), may be behind the flange(s), or the like. The tear strip can be pulled to tear a flange opening through the one or more flanges to provide access to the interlocking profile bodies. The flange edges of the zipper assembly can be coupled with the bag edges so that the closed end of the zipper assembly and the tear strip are disposed outside of the interior volume and outside of the mouth opening of the bag. In contrast to some known bag assemblies having tear strips along top edges, top bends, or top folds in the bag assemblies, one or more examples of the zipper assemblies described herein may position the tear strip along a front side or surface of the bag assembly, which also can be the surface of the bag assembly that is presented to a consumer and may include indicia identifying the product inside the bag assembly and/or the entity manufacturing or selling the product.

The interlocking bodies can be disposed between the tear strip and the mouth opening of the bag. The web(s) of material can form a front panel and an opposing rear panel of the bag. The flange edges of the zipper assembly can be disposed within the mouth opening of the bag in a location that is between the front panel and the rear panel of the bag. The flange(s) can include exterior surfaces facing away from each other and extending to the flange edges. The exterior surfaces can be coupled with interior surfaces of the front panel and the rear panel of the bag that face each other.

The flange(s) can include a front flange and a rear flange. The front flange can extend from an upper front flange edge to a first flange edge of the flange edges. The rear flange can extend from an upper rear flange edge to a second flange edge of the flange edges. The front flange and the rear flange can be sealed together in a location that is closer to (a) the closed end of the zipper assembly, the upper front flange edge, and/or the upper rear flange edge than any of (b) the tear strip, the interlocking bodies, the first flange edge, or the second flange edge.

The flange(s) can include a single continuous flange having a bend at the closed end of the zipper assembly. The zipper assembly can include (a) both front and rear flanges as the one or more flanges or (b) a single flange as the one or more flanges with the single flange having a bend at the closed end with a front portion and a rear portion on opposite sides of the bend. The bag assembly also can include a lower horizontal seal coupling the front and rear flanges or coupling the front portion and the rear portion and located between the tear strip and the bag, an upper horizontal seal coupling the front and rear flanges or coupling the front portion and the rear portion and located between the tear strip and the closed end of the zipper assembly, and/or a side seal between the front and rear flanges or coupling the front portion and the rear portion and encapsulating an opening through the zipper assembly through which the tear strip is accessible.

A method can include obtaining an open-ended bag formed from one or more webs of material that partially enclose an interior volume. The bag can have one or more bag edges extending around and defining a mouth opening of the bag through which the interior volume is accessible. The method can include obtaining a zipper assembly comprising a tear strip, one or more flanges, and interlocking profile bodies protruding from the one or more flanges. The interlocking profile bodies can repeatedly mate with each other to seal the mouth opening closed and separate from each other to open the mouth opening. The zipper assembly can extend from a closed end to an opposite open end with the one or more flanges extending from the closed end to opposing flange edges located at the open end of the zipper assembly. The tear strip can be pulled to tear a flange opening through the one or more flanges to provide access to the interlocking profile bodies. The method also can include sealing the flange edges of the zipper assembly with the bag closer to the bag edges than the interior volume so that the closed end of the zipper assembly and the tear strip are disposed outside of the interior volume and outside of the mouth opening of the bag.

The flange(s) can include a front flange and a rear flange. The flange edges can be lower flange edges. Each of the front flange and the rear flange can extend from one of the lower flange edges to an opposite upper flange edge. The method also can include sealing the front flange and the rear flange together in a location closer to the upper flange edges than the lower flange edges.

Optionally, the flange(s) can include a single continuous flange that extends from a first flange edge of the flange edges to an opposite second flange edge of the flange edges. The bag assembly can also include bending the single continuous flange between the first flange edge and the second flange edge prior to sealing the first and second flange edges to the bag.

Another bag assembly can include an open-mouthed bag partially extending around an interior volume and an open-mouthed zipper assembly having interlocking bodies protruding from one or more flanges and shaped to repeatedly mate with each other and separate from each other. The zipper assembly can include a tear strip that can be pulled to form a first opening through the zipper assembly. The zipper assembly and the open-mouthed bag can be sealed to each other to surround and enclose the interior volume of the bag with the tear strip and the interlocking bodies located outside of the open-mouthed bag.

The zipper assembly may have flanges coupled to each other along three edges. Each flange can include at least one of the interlocking bodies, with at least one (or only one) of the flanges having the tear strip. The zipper assembly can include a flange that is folded along a bend and coupled to itself along opposite side edges with the tear strip located between the bend and a bottom edge of the flange.

The zipper assembly can include a second opening through which the tear strip is accessed to be pulled and form the first opening. The interlocking bodies can be located between the second opening and the open-mouthed bag. The zipper assembly can extend into the open-mouthed bag. Optionally, the open-mouthed bag can extend into the zipper assembly.

The interlocking bodies can be disposed between (a) a seal between the open-mouthed bag and the zipper assembly and (b) the tear strip. The interlocking bodies can repeatedly mate and separate from each other to repeatedly seal and unseal the interior volume after the tear strip is pulled to form the first opening.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A resealable bag assembly comprising:
one or more webs of material defining an open-ended bag that partially encloses an interior volume, the bag having one or more bag edges extending around and defining a mouth opening of the bag through which the interior volume is accessible; and
a zipper assembly comprising a tear strip, one or more flanges, and interlocking profile bodies protruding from the one or more flanges, the interlocking profile bodies configured to repeatedly mate with each other to seal the mouth opening closed and separate from each other to open the mouth opening,
the zipper assembly extending from a closed end to an opposite open end with the one or more flanges extending from the closed end to opposing flange edges located at the open end of the zipper assembly, the tear strip located between the closed end and the open end of the zipper assembly, the tear strip configured to be pulled to tear a flange opening through the one or more flanges to provide access to the interlocking profile bodies, the flange edges of the zipper assembly coupled with the bag edges so that the closed end of the zipper assembly and the tear strip are disposed outside of the interior volume and outside of the mouth opening of the bag.

2. The resealable bag assembly of claim 1, wherein the interlocking profile bodies are disposed between the tear strip and the mouth opening of the bag.

3. The resealable bag assembly of claim 1, wherein the one or more webs of material form a front panel and an opposing rear panel of the bag, and the flange edges of the zipper assembly are disposed within the mouth opening of the bag in a location that is between the front panel and the rear panel of the bag.

4. The resealable bag assembly of claim 3, wherein the one or more flanges include exterior surfaces facing away from each other and extending to the flange edges, the exterior surfaces coupled with interior surfaces of the front panel and the rear panel of the bag that face each other.

5. The resealable bag assembly of claim 1, wherein the one or more flanges include a front flange and a rear flange, the front flange extending from an upper front flange edge to a first flange edge of the flange edges, the rear flange extending from an upper rear flange edge to a second flange edge of the flange edges.

6. The resealable bag assembly of claim 5, wherein the front flange and the second flange edge are sealed together in a location that is closer to (a) the closed end of the zipper assembly, the upper front flange edge, and the upper rear flange edge than any of (b) the tear strip, the interlocking profile bodies, the first flange edge, or the second flange edge.

7. The resealable bag assembly of claim 1, wherein the one or more flanges include a single continuous flange having a bend at the closed end of the zipper assembly.

8. The resealable bag assembly of claim 1, wherein the zipper assembly includes (a) front and rear flanges as the one or more flanges or (b) a single flange as the one or more flanges with the single flange having a bend at the closed end with a front portion and a rear portion on opposite sides of the bend, and further comprising one or more of:
a lower horizontal seal coupling the front and rear flanges or coupling the front portion and the rear portion and located between the tear strip and the bag;
an upper horizontal seal coupling the front and rear flanges or coupling the front portion and the rear portion and located between the tear strip and the closed end of the zipper assembly; or
a side seal between the front and rear flanges or coupling the front portion and the rear portion and encapsulating an opening through the zipper assembly through which the tear strip is accessible.

9. A method comprising:
obtaining an open-ended bag formed from one or more webs of material that partially enclose an interior volume, the bag having one or more bag edges extending around and defining a mouth opening of the bag through which the interior volume is accessible;
obtaining a zipper assembly comprising a tear strip, one or more flanges, and interlocking profile bodies protruding from the one or more flanges, the interlocking profile bodies configured to repeatedly mate with each other to seal the mouth opening closed and separate from each other to open the mouth opening, the zipper assembly extending from a closed end to an opposite open end with the one or more flanges extending from the closed end to opposing flange edges located at the open end of the zipper assembly, the tear strip configured to be pulled to tear a flange opening through the one or more flanges to provide access to the interlocking profile bodies; and
sealing the flange edges of the zipper assembly with the bag closer to the bag edges than the interior volume so that the closed end of the zipper assembly and the tear strip are disposed outside of the interior volume and outside of the mouth opening of the bag.

10. The method of claim 9, wherein the one or more flanges include a front flange and a rear flange, the flange edges are lower flange edges, and each of the front flange and the rear flange extends from one of the lower flange edges to an opposite upper flange edge, and further comprising:
sealing the front flange and the rear flange together in a location closer to the upper flange edges than the lower flange edges.

11. The method of claim 9, wherein the one or more flanges include a single continuous flange that extends from a first flange edge of the flange edges to an opposite second flange edge of the flange edges, and further comprising:
bending the single continuous flange between the first flange edge and the second flange edge prior to sealing the first and second flange edges to the bag.

12. A bag assembly comprising:
an open-mouthed bag partially extending around an interior volume; and
an open-mouthed zipper assembly having interlocking bodies protruding from one or more flanges and shaped to repeatedly mate with each other and separate from each other, the zipper assembly including a tear strip configured to be pulled to form a first opening through the zipper assembly, the zipper assembly and the open-mouthed bag sealed to each other to surround and enclose the interior volume of the bag with the tear strip and the interlocking bodies located outside of the open-mouthed bag.

13. The bag assembly of claim 12, wherein the zipper assembly includes flanges coupled to each other along three edges and each including at least one of the interlocking bodies, one of the flanges including the tear strip.

14. The bag assembly of claim 12, wherein the zipper assembly includes a flange that is folded along a bend and coupled to itself along opposite side edges with the tear strip located between the bend and a bottom edge of the flange.

15. The bag assembly of claim 12, wherein the zipper assembly includes a second opening through which the tear strip is accessed to be pulled and form the first opening.

16. The bag assembly of claim 15, wherein the interlocking bodies are located between the second opening and the open-mouthed bag.

17. The bag assembly of claim 12, wherein the zipper assembly extends into the open-mouthed bag.

18. The bag assembly of claim 12, wherein the open-mouthed bag extends into the zipper assembly.

19. The bag assembly of claim 12, wherein the interlocking bodies are disposed between (a) a seal between the open-mouthed bag and the zipper assembly and (b) the tear strip.

20. The bag assembly of claim 12, wherein the interlocking bodies are configured to repeatedly mate and separate from each other to repeatedly seal and unseal the interior volume after the tear strip is pulled to form the first opening.
